(19) United States
(12) Patent Application Publication
(10) Pub. No.: US 2022/0242617 A1
(43) Pub. Date: Aug. 4, 2022

(54) Suspension Device, and Package

(71) Applicant: WestRock Packaging Systems, LLC, Atlanta, GA (US)

(72) Inventor: Katsuo SHIBUYA, Tokyo (JP)

(21) Appl. No.: 17/298,354

(22) PCT Filed: Nov. 27, 2019
(86) PCT No.: PCT/JP2019/046287

§ 371 Date: Feb. 22, 2022

(30) Foreign Application Priority Data
Nov. 30, 2018 (JP) 2018-225286

(51) Int. Cl. B65D 25/20; B65D 71/28

(52) U.S. Cl. CPC B65D 25/20; B65D 2571/00444; B65D 71/28

(57) ABSTRACT

A hanging device (16) detachably attached to an opening (28a, 28b) of a package (14), the hanging device (16) including a connection flap (32) and a tote main body (34) connected to the connection flap (32), wherein the connection flap (32) has at least one engagement mechanism (37) that detachably engages with the opening (28a, 28b) of the package (14), the at least one engagement mechanism (37) includes a primary tab (38a, 38b) disposed at the opening (28a, 28b) of the package (14) and an auxiliary tab (40a, 40b) connected to the primary tab (38a, 38b), the primary tab (38a, 38b) is connected to the connection flap (32) in the form of hinge connection along a virtual line, and when the hanging device (16) is developed, the auxiliary tab (40a, 40b) extends from the virtual line in the direction opposite the direction in which the primary tab (38a, 38b) extends.

### BACKGROUND OF THE INVENTION

### Field of the Invention

The present invention relates to a hanging device and a package, particularly to improvement of an engagement mechanism of a hanging device.

The present application claims the priority based on Japanese Patent Application No. 2018-225286 filed in Japan on Nov. 30, 2018 and incorporates the content thereof herein by reference.

### Description of the Related Art

There has been a known package that packages an object to be packaged, such as a cylindrical can filled with a beverage (U.S. Pat. Nos. 3,432,029, 5,311,994, and International Publication No. WO 2006/083941, for example). In recent years, among such packages, attention has been particularly paid to a multi-package capable of packaging two or more identical packaged objects together.

A paperboard is primarily used as a packaging material in many cases. A package is completed by wrapping a packaged object with a packaging material, such as a paperboard, and locking and sealing a lower portion of the wrapped packaging material.

Such a package is advantageous, for example, in that the object to be packaged can be readily packaged, the packaged object is readily carried, and a display effect is provided.

Such a package having the variety of advantages described above is still required to provide a further enhanced advertise effect resulting from the packaged object. To satisfy the requirement, it is conceivable to add a hanging device on which advertisement or any other information is displayed to the package.

A hanging device, however, has room for improvement in ease of handling. That is, a hanging device attached to a package comes off the package in some cases, for example, during transportation, and it is therefore necessary to handle the package with care, resulting in troublesome handling.

In related art, to prevent the hanging device from coming off the package, for example, during transportation, it has been conceivable that the hanging device is more securely fixed to the package. However, securely fixing the hanging device to the package makes it difficult in some cases to remove the hanging device from the package when the package is unsealed, resulting in troublesome handling.

As described above, it has been difficult for one hanging device to not only make the device unlikely to come off the package but make the device readily removable from the package. Therefore, even a hanging device that provides an excellent advertisement effect has room for improvement in ease of handling, and there has been no appropriate technology that can achieve any improvement.

### SUMMARY OF THE INVENTION

The present invention has been made in view of the problem described above with the related art, and an object of the present invention is to provide a hanging device and a package that are readily handled.

### <Hanging Device>

To achieve the object described above, a hanging device according to an aspect of the present invention is a hanging device detachably attached to an opening of a package, the hanging device including a connection flap and a tote main body.

The connection flap has at least one engagement mechanism. The at least one engagement mechanism detachably engages with the opening of the package. The at least one engagement mechanism includes a primary tab disposed at the opening of the package and an auxiliary tab connected to the primary tab. The primary tab is connected to the connection flap in the form of hinge connection along a virtual line. The “virtual line” used herein is a literally imaginary line and is not actually visible. When the hanging device is developed, the auxiliary tab extends from the virtual line in a direction opposite a direction in which the primary tab extends.

The tote main body is connected to the connection flap.

In the aspect of the present invention, in the case where the folding line for primary tab and/or the folding line for auxiliary tab are used, the folding lines extend along the virtual line. It is, however, noted that the folding lines can be omitted as required. In the aspect of the present invention, the primary tab is so sized as to be detachably attached to the opening of the package. In the aspect of the present invention, the auxiliary tab is smaller than the primary tab. In the aspect of the present invention, the folding line for auxiliary tab is shorter than the folding line for primary tab. In the aspect of the present invention, the center of the folding line for primary tab coincides with the center of the folding line for auxiliary tab. In the aspect of the present invention, the folding line for primary tab and the folding line for auxiliary tab are so provided that one end and the other end of the folding line for primary tab face each other with the folding line for auxiliary tab sandwiched therebetween.

In the hanging device according to the aspect of the present invention, the primary tab is connected to the connection flap along a folding line for primary tab, the auxiliary tab is connected to the primary tab along a folding line for auxiliary tab, and the folding line for primary tab is aligned with the virtual line with which the folding line for auxiliary tab is aligned. That is, the folding line for primary tab and the folding line for auxiliary tab are aligned with the same straight line.

In the hanging device according to the aspect of the present invention, the at least one engagement mechanism includes a pair of engagement mechanisms so disposed as to face each other, and when the hanging device is developed, the auxiliary tabs of the engagement mechanisms extend from the corresponding primary tabs in opposite directions.

In the hanging device according to the aspect of the present invention, the tote main body is connected to the connection flap along a folding line for tote main body, and the folding line for auxiliary tab is so disposed as to be perpendicular to the folding line for tote main body.

In the hanging device according to the aspect of the present invention, the tote main body may be connected to the connection flap along a folding line for tote main body, and the virtual line may be so disposed as to be parallel to the folding line for tote main body.

In the hanging device according to the aspect of the present invention, the at least one engagement mechanism is a portion at least partially stamped off the connection flap.

### <Package>

To achieve the object described above, a package according to another aspect of the present invention is a package including a packaged object, a carton, and a hanging device. The packaged object is at least one packaged object. The carton is a package at least partially disposed around the at least one packaged object. The hanging device is detachably attached to the carton. The carton includes a plurality of wall panels connected in the form of hinge connection to each other. The plurality of wall panels include a top wall panel. The top wall panel has a carrying handle. The carrying handle has at least one finger-hooked opening. The hanging device includes a tote main body disposed along at least part of an exterior of the carton and a connection flap having at least one engagement mechanism that engages with the at least one finger-hooked opening of the carton. The at least one engagement mechanism includes a primary tab disposed at the at least one finger-hooked opening and an auxiliary tab connected to the primary tab. The primary tab is connected to the connection flap in the form of hinge connection along a virtual line. The “virtual line” used herein is an imaginary line and is not actually visible. When the hanging device is developed, the auxiliary tab extends from the virtual line in a direction opposite a direction in which the primary tab extends.

In the package according to the other aspect of the present invention, the plurality of wall panels define a tubular structure having at least one open end, and the tote main body is provided in a position where the tote main body at least partially closes the at least one open end of the tubular structure.

### Advantages of the Invention

In the hanging device according to the aspect of the invention, since the primary tab and the auxiliary tab are disposed on the same virtual line, the single hanging device can be unlikely to come off or readily removed. That is, when the primary tab and the auxiliary tab are folded inward, the hanging device can be unlikely to come off. On the other hand, when the auxiliary tab is folded outward, the hanging device can be readily removed. As described above, the hanging device according to the aspect of the invention can be readily handled because the auxiliary tab allows the single hanging device to be unlikely to come off or readily removed.

In the hanging device according to the aspect of the invention, since the folding line for the primary tab and the folding line for the auxiliary tab are disposed on the same straight line (same virtual line), the above-mentioned following two effects of the single hanging device can be more reliably provided: the hanging device is unlikely to come off; and the hanging device is readily removed.

The hanging device according to the aspect of the invention includes a pair of engagement mechanisms so disposed as to face each other, and the auxiliary tabs of the engagement mechanisms extend from the corresponding primary tabs in opposite directions, whereby the above-mentioned following two effects of the single hanging device can be more reliably provided: the hanging device is unlikely to come off; and the hanging device is readily removed.

In the hanging device according to the aspect of the invention, since the tote main body is connected to the connection flap along a folding line for tote main body, and the folding line for auxiliary tab is so disposed as to be perpendicular to the folding line for tote main body, the tote main body can be disposed in a desired portion of the package. The hanging device can therefore be more readily handled.

In the hanging device according to the aspect of the invention, since the tote main body is connected to the connection flap along a folding line for tote main body, and the virtual line passing through the folding line for primary tab and the folding line for auxiliary tab are so disposed as to be parallel to the folding line for tote main body, the tote main body can be provided in a desired portion of the package in an arrangement different from the arrangement of the tote main body according to the aspect of the invention. The hanging device can therefore be more readily handled.

In the hanging device according to the aspect of the invention, since the at least one engagement mechanism is a portion at least partially stamped off the connection flap, the configuration of the engagement mechanism can be further simplified, whereby the hanging device can be more readily handled.

Since the package according to the other aspect of the invention includes the hanging device according to the aspect of the invention, the hanging device can be readily handled because the auxiliary tab allows the single hanging device to be unlikely to come off or readily removed.

In the package according to the other aspect of the invention, the tote main body can at least partially close the at least one open end of the tubular structure.

### BRIEF DESCRIPTION OF THE DRAWINGS

FIG. 1 is a perspective view of the exterior appearance of a package using a hanging device according to a first embodiment of the present invention;

FIG. 2 is a plan view showing the hanging device shown in FIG. 1 in the developed state;

FIG. 3 describes the hanging device shown in FIG. 1 with auxiliary tabs thereof folded inward;

FIG. 4 describes the hanging device shown in FIG. 1 with the auxiliary tabs thereof folded outward;

FIG. 5 is a perspective view of the exterior appearance of a package using a hanging device according to a second embodiment of the present invention;

FIG. 6 is a plan view showing the hanging device shown in FIG. 5 in the developed state;

FIG. 7 is a plan view showing a developed carton that forms the package according to the first embodiment of the present invention; and

FIG. 8 is a perspective view of the exterior appearance of a package using a hanging device according to a third embodiment of the present invention.

### DETAILED DESCRIPTION OF THE PREFERRED EMBODIMENTS

Preferable embodiments of the present invention will be described below with reference to the drawings.

### First Embodiment

### <Package>

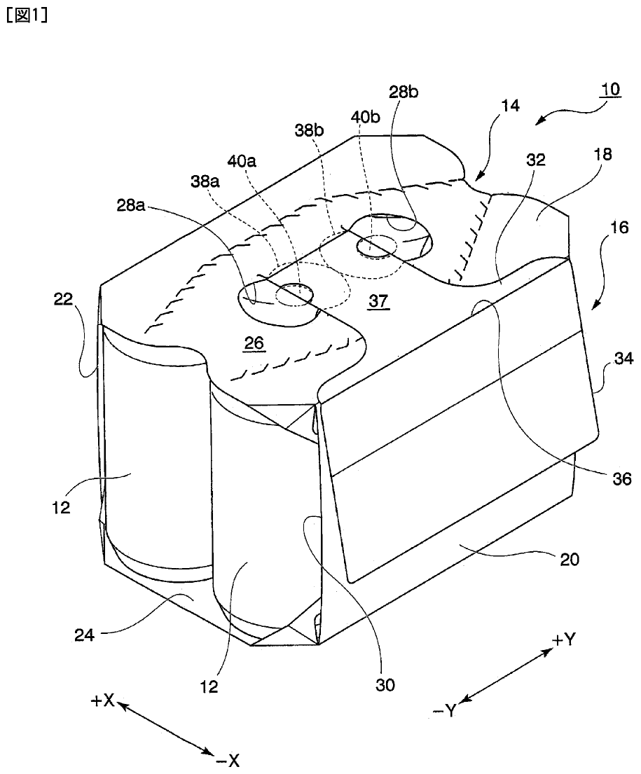

FIG. 1 shows a package according to a first embodiment of the present invention.

A package 10 shown in FIG. 1 includes beer cans (packaged object) 12, a carton 14, and a hanging device 16.

In the present embodiment, six beer cans 12 are arranged in a 2×3 matrix as the packaged object in the present invention.

The carton in the present invention is a package at least partially disposed around at least one packaged object. In the present embodiment, the carton 14 is disposed around the beer cans 12 arranged in a 2×3 matrix. The carton in the present invention includes a plurality of wall panels connected to each other in the form of hinge-type connection. In the present embodiment, the plurality of wall panels are formed of a top wall panel 18, sidewall panels 20 and 22, and a bottom wall panel 24. In the present embodiment, the carton 14 is a carton having a tubular structure and has two open ends. FIG. 1 only shows one open end 30 of the tubular structure of the carton 14. The top wall panel 18 includes a carrying handle 26. The carrying handle 26 has finger-hooked openings 28a and 28b.

The hanging device 16 is detachably attached to the finger-hooked openings 28a and 28b formed in the top wall panel 18 of the carton 14. The hanging device 16 includes a connection flap 32 and a tote main body 34.

The connection flap 32 includes an engagement mechanism 37. The engagement mechanism 37 of the connection flap 32 detachably engages with the finger-hooked openings 28a and 28b of the carrying handle 26 of the top wall panel 18 of the carton 14. The engagement mechanism 37 of the connection flap 32 includes primary tabs 38a and 38b and auxiliary tabs 40a and 40b.

The primary tabs 38a and 38b are each a tab having a free-end-side shape with a roughly C-letter-shaped contour. The base ends of the primary tabs 38a and 38b are connected in the form of hinge-type connection to the connection flap 32 along folding lines 50a and 50b for primary tabs. In FIG. 1, the primary tabs 38a and 38b are disposed in the finger-hooked openings 28a and 28b of the top wall panel 18 of the carton 14 and folded inward.

The auxiliary tabs 40a and 40b are each a tab having a free-end-side shape with a roughly semicircular contour. The base ends of the auxiliary tabs 40a and 40b are connected in the form of hinge-type connection to the base ends of the primary tabs 38a and 38b along folding lines 52a and 52b for auxiliary tabs. That is, the folding lines of the auxiliary tabs 40a and 40b are disposed on virtual lines Xa-Xa and Xb-Xb, on which the folding lines of the primary tabs 38a and 38b are also disposed. In FIG. 1, the auxiliary tabs 40a and 40b are folded inward, as are the primary tabs 38a and 38b disposed in the finger-hooked openings 28a and 28b of the top wall panel 18 of the carton 14, and cover from below the primary tabs 38a and 38b folded inward in the carton 14.

In the present embodiment, the tote main body 34 has a panel-like shape and is connected to the connection flap 32 via a folding line 36 for tote main body. The tote main body 34 is folded along the folding line 36 for tote main body. As a result, the hanging device 16 is so configured that the connection flap 32 is disposed along part of the outer surface of the top wall panel 18 of the carton 14 and the tote main body 34 is disposed along the outer surface of the sidewall panel 20. In the present embodiment, the panel-shaped tote main body 34 connected to the connection flap 32 forms an advertisement panel.

According to the present embodiment, the hanging device 16 can be readily added to the carton 14 by causing the engagement mechanism 37 of the hanging device 16 to engage with the finger-hooked openings 28a and 28b of the top wall panel 18 of the carton 14.

In particular, according to the present embodiment, the tote main body 34 of the hanging device 16 is disposed along the outer surface of the sidewall panel 20 of the carton 14, whereby the hanging device 16 can provide an advertisement different from an advertisement displayed on the sidewall panel 20.

The hanging device 16 is detachably attached to the finger-hooked openings 28a and 28b of the top wall panel 18 of the carton 14. Since the folding line for the primary tab 38a and the folding line for the auxiliary tab 40a are disposed on the same straight line, and the folding line for the primary tab 38b and the folding line for the auxiliary tab 40a are disposed on the same straight line, the single hanging device 16 can be readily removed or unlikely to come off. That is, when the auxiliary tabs 40a and 40b are folded inward, the hanging device 16 can be unlikely to come off the carton 14, for example, during transportation. On the other hand, when the auxiliary tabs 40a and 40b are folded outward, the hanging device 16 can be readily removed from the carton 14, for example, in the operation of unsealing the carton 14 to take out the beer cans 12. A user can thus handle the hanging device 16 with a smaller amount of pain.

### <Hanging Device>

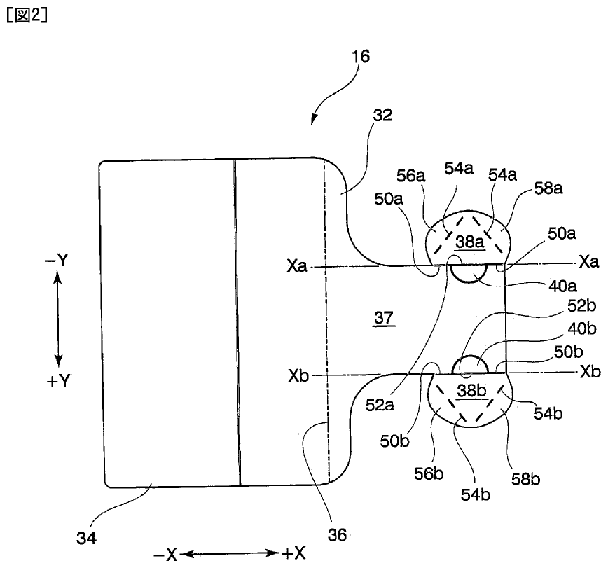

The hanging device 16 will be more specifically described below. FIG. 2 shows the hanging device 16 shown in FIG. 1 in the developed state. The engagement mechanism 37 includes the primary tabs 38a and 38b and the auxiliary tabs 40a and 40b.

The primary tabs 38a and 38b are each a tab having a free-end-side shape with a roughly C-letter-shaped contour. The primary tab 38a extends from the folding line 50a for primary tab in the direction −Y in FIG. 2. The primary tab 38b extends from the folding line 50b for primary tab in the direction (direction +Y in FIG. 2) opposite the direction in which the primary tab 38a extends (direction −Y in FIG. 2).

The base end of the primary tab 38a is connected to the connection flap 32 via the folding line 50a for primary tab. The base end of the primary tab 38b is connected to the connection flap 32 via the folding line 50b for primary tab.

When the primary tabs 38a and 38b are folded inward, the free ends of the primary tabs 38a and 38b pivot around the folding lines 50a and 50b for primary tabs. When the primary tabs 38a and 38b are folded inward along the folding lines 50a and 50b for primary tabs, the base ends of the primary tabs 38a and 38b are in contact with the edges of the finger-hooked openings formed in the top wall panel of the carton, and the free ends of the primary tabs 38a and 38b are located in the carton inward from the edges of the finger-hooked openings of the top wall panel. On the other hand, when the primary tabs 38a and 38b are folded outward, the free ends of the primary tabs 38a and 38b pivot around the folding lines 50a and 50b for primary tabs in the direction opposite the inward folding direction.

The engagement mechanism 37 in the present invention is a portion at least partially stamped off the connection flap 32. In the present embodiment, the auxiliary tabs 40a and 40b are each a roughly semicircular tab defined by a roughly semicircular breaking line. That is, the free ends of the auxiliary tabs 40a and 40b are ends stamped off the connection flap 32.

The base ends of the auxiliary tabs 40a and 40b are connected to the base ends of the primary tabs 38a and 38b. That is, the base end of the auxiliary tab 40a is connected to the base end of the primary tab 38a via the folding line 52a for auxiliary tab. The base end of the auxiliary tab 40b is connected to the base end of the primary tab 38b via the folding line 52b for auxiliary tab. When the auxiliary tabs 40a and 40b are folded inward, the free ends of the auxiliary tabs 40a and 40b pivot around the folding lines 52a and 52b for auxiliary tabs. When the auxiliary tabs 40a and 40b are folded inward along the folding lines 52a and 52b for auxiliary tabs, the base ends (folding lines) of the auxiliary tabs 40a and 40b are located on the straight lines that coincide with the base ends (folding lines) of the primary tabs that are in contact with the edges of the finger-hooked openings formed in the top wall panel of the carton, and the free ends of the auxiliary tabs 40a and 40b overlap from below in the carton with the free ends of the primary tabs 38a and 38b located inward from the edges of the finger-hooked openings of the top wall panel.

That is, the folding line 50a for primary tab is aligned with the straight line (virtual line Xa-Xa in FIG. 2) with which the folding line 52a for auxiliary tab is aligned. The folding line 50b for primary tab is aligned with the straight line (virtual line Xb-Xb in FIG. 2) with which the folding line 52b for auxiliary tab is aligned. In the present embodiment, the virtual lines Xa-Xa and Xb-Xb are used as the virtual lines in the present invention. In the present embodiment, the virtual line Xa-Xa is a virtual line passing through the folding line 50a for primary tab and the folding line 52a for auxiliary tab. In the present embodiment, the virtual line Xb-Xb is a virtual line passing through the folding line 50b for primary tab and the folding line 52b for auxiliary tab.

The auxiliary tabs of the engagement mechanism in the present invention extend from the corresponding primary tabs in opposite directions. In the present embodiment, the auxiliary tab 40a extends in the direction (direction +Y in FIG. 2) opposite the direction in which the primary tab 38a extends with the folding line 52a for auxiliary tab (folding line 50a for primary tab) sandwiched between the auxiliary tab 40a and the primary tab 38a in FIG. 2. As described above, in the present embodiment, when the hanging device 16 is developed, the free end of the auxiliary tab 40a and the free end of the auxiliary tab 40b extend in opposite directions.

The tote main body 34 is connected to the connection flap 32 along the folding line 36 for tote main body. The direction in which the folding lines 50a and 50b for primary tabs extend is the direction X in FIG. 2. The direction in which the folding lines 52a and 52b for auxiliary tabs extend is the direction X in FIG. 2. On the other hand, the direction in which the folding line 36 for tote main body extends is the direction Y in FIG. 2. That is, the virtual line Xa-Xa, which passes through the folding line 50a for primary tab and the folding line 52a for auxiliary tab, is so disposed as to extend in the direction (direction X in FIG. 2) perpendicular to the direction in which the folding line 36 for tote main body extends (direction Y in FIG. 2).

The primary tab 38a has folding lines 54a formed therein, and the folding lines 54a form a roughly triangular folding line when the folding lines 54a are combined with the folding line 50a for primary tab. The folding lines 54a form inward foldable tongue-shaped sections 56a and 58a as part of the primary tab 38a. When the primary tab 38a is folded inward, the inward foldable tongue-shaped sections 56a and 58a extend along the beer cans in the carton.

The primary tab 38b has folding lines 54b formed therein, and the folding lines 54b form a roughly triangular folding line when the folding lines 54b are combined with the folding line 50b for primary tab, as does the primary tab 38a. The folding lines 54b form inward foldable tongue-shaped sections 56b and 58b as part of the primary tab 38b. When the primary tab 38b is folded inward, the inward foldable tongue-shaped sections 56b and 58b extend along the beer cans in the carton.

The hanging device 16 according to the present embodiment is roughly configured as described above, and the effect of the hanging device 16 will be described below.

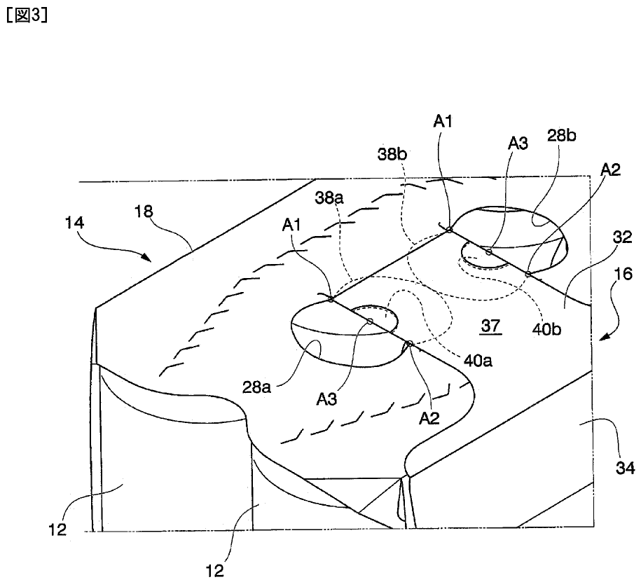

FIG. 3 shows the hanging device 16 according to the present embodiment securely attached to the carton 14. When the hanging device 16 according to the present embodiment is securely attached to the carton 14, the primary tabs 38a and 38b and the auxiliary tabs 40a and 40b are folded inward, as shown in FIG. 3.

More specifically, when the primary tabs 38a and 38b of the hanging device 16 are folded inward as shown in FIG. 3, the base ends of the primary tabs 38a and 38b are intimately in contact with the edges of the finger-hooked openings 28a and 28b. In particular, the base ends of the primary tabs 38a and 38b are strongly in contact with areas A1, A2, and A3 of the edges of the finger-hooked openings 28.

When the auxiliary tabs 40a and 40b of the hanging device 16 are folded inward as shown in FIG. 3, the auxiliary tabs 40a and 40b can reliably hold the inward folded primary tabs 38a and 38b described above. In particular, the auxiliary tabs 40a and 40b cause the areas A3 of the edges of the finger-hooked openings 28a and 28b to be more strongly in contact with the base portions of the primary tabs 38a and 38b. When the primary tabs 38a and 38b and the auxiliary tabs 40a and 40b are folded inward, the auxiliary tabs 40a and 40b cause the primary tabs 38a and 38b to be more strongly in contact particularly with the areas A1, A2 and A3 of the edges of the finger-hooked openings 28a and 28b. The inward folded primary tabs 38a and 38b can therefore be more reliably held, whereby the primary tabs 38a and 38b can be more reliably held at the edges of the finger-hooked openings 28a and 28b of the top wall panel 18.

As described above, when the primary tabs 38a and 38b and the auxiliary tabs 40a and 40b of the hanging device 16 are folded inward as shown in FIG. 3, the hanging device 16 cannot be readily removed from the top wall panel 18 of the carton 14 even when the hanging device 16 is pulled.

The hanging device 16 according to the present embodiment can be readily removed from the carton 14.

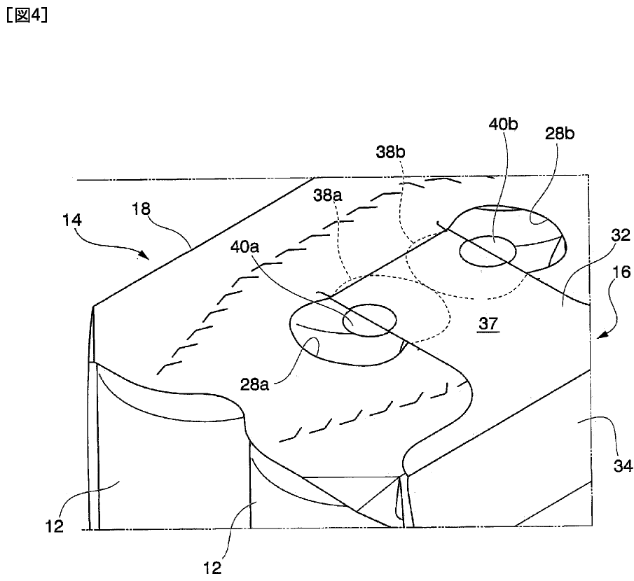

FIG. 4 shows that the hanging device 16 according to the present embodiment is readily removed from the carton 14. To allow the hanging device 16 according to the present embodiment to be readily removed from the carton 14, the auxiliary tabs 40a and 40b having been folded inward are folded outward, as shown in FIG. 4.

When the auxiliary tabs 40a and 40b are folded outward as shown in FIG. 4, the free ends of the primary tabs 38a and 38b also slightly pivot in the direction in which the degree of the inward folded state of the primary tabs 38a and 38b decreases. The pivotal motion cancels the state in which the base ends of the primary tabs 38a and 38b are strongly in contact with the areas A1, A2, and A3 of the finger-hooked openings 28a and 28b of the top wall panel 18 of the carton 14.

Therefore, in the state in which the auxiliary tabs 40a and 40b of the hanging device 16 are folded outward as shown in FIG. 4, pulling the hanging device 16 allows the primary tabs 38a and 38b of the hanging device 16 to be readily pulled out of the finger-hooked openings 28a and 28b of the top wall panel 18 of the carton 14. As described above, the outward folded auxiliary tabs 40a and 40b allow the hanging device 16 to be readily removed from the carton 14. More specifically, the following effects are provided: the hanging device 16 is readily removed; the load produced when the finger-hooked openings are grabbed is distributed so that the pain due to the folding lines decreases; and the outward folded auxiliary tabs each have a tongue-like shape, and grabbing the outward folded auxiliary tabs allows the hanging device to be readily removed.

As described above, providing the connection flap 32 of the hanging device 16 with the roughly semicircular auxiliary tabs 40a and 40b allows the single hanging device 16 to provide the following two effects: the hanging device 16 is unlikely to come off; and the hanging device 16 is readily removed.

### Second Embodiment

### <Package>

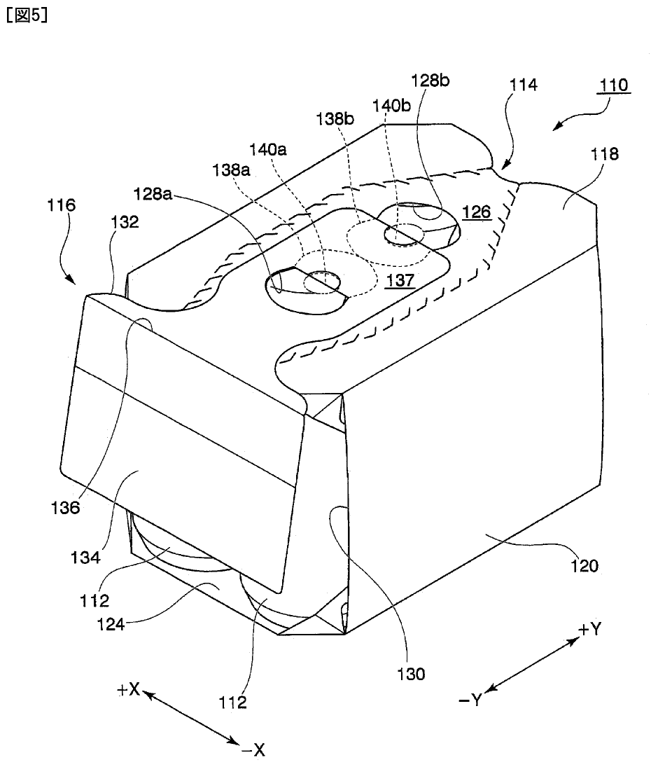

FIG. 5 shows a schematic configuration of a package using a hanging device according to a second embodiment of the present invention. Portions corresponding to those in FIG. 1 are labeled with the corresponding reference characters to which 100 is added and will not be described.

The first embodiment has been described with reference to the case where the tote main body of the hanging device is provided along the outer surface of one of the sidewall panels of the carton. In the present embodiment, however, a tote main body 134 is not provided along the outer surface of a sidewall panel 120. That is, in the present embodiment, the tote main body 134 partially closes an open end 130 of a carton 114 having the tubular structure.

According to the present embodiment, in which a hanging device 116 is provided at the open end 130 of the carton 114, an advertisement on the tote main body 134 can be provided in addition to an advertisement displayed on the sidewall panel 120. The present embodiment therefore allows a larger number of advertisements to be displayed than in the first embodiment. Further, according to the present embodiment, the tote main body 134 can also protect beer cans 112 located in the vicinity of the open end 130 of the carton 114.

### <Hanging Device>

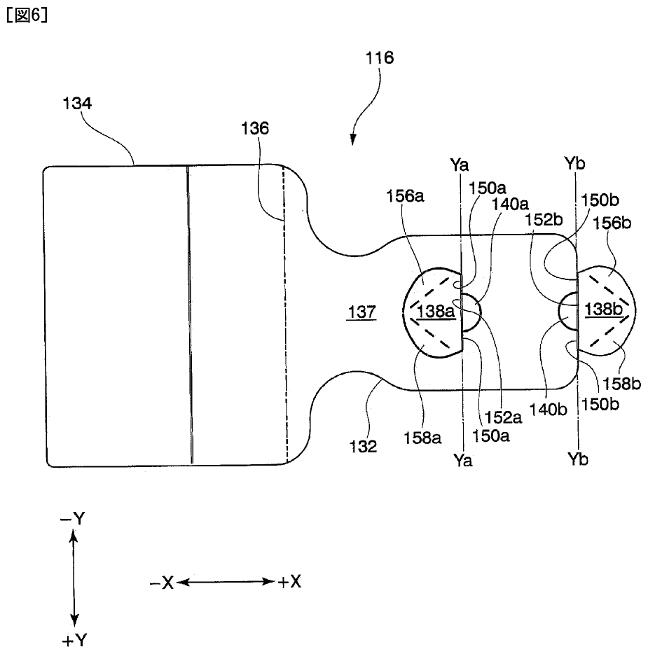

The hanging device according to the second embodiment of the present invention will be more specifically described below. Portions corresponding to those in FIG. 2 are labeled with the corresponding reference characters to which 100 is added and will not be described. FIG. 6 shows the hanging device 116 shown in FIG. 5 in the developed state. The tote main body 134 shown in FIG. 6 is connected to a connection flap 132 along a folding line 136 for tote main body.

The virtual lines in the present embodiment are disposed in parallel to the folding line for tote main body. In the present embodiment, the direction in which folding lines 150a and 150b for primary tabs extend is the direction Y in FIG. 6. The direction in which folding lines 152a and 152b for auxiliary tabs extend is also the direction Y in FIG. 6. The direction in which the folding line 136 for tote main body extends is also the direction Y in FIG. 6. The direction in which a virtual line Ya-Ya, which passes through the folding line 150a for primary tab and the folding line 152a for auxiliary tab, extends (direction Y in FIG. 6) is parallel to the direction in which the folding line 136 for tote main body extends (direction Y in FIG. 6). The direction in which a virtual line Yb-Yb, which passes through the folding line 150b for primary tab and the folding line 152b for auxiliary tab, extends (direction Y in FIG. 6) is also parallel to the direction in which the folding line 136 for tote main body extends (direction Y in FIG. 6). In the present embodiment, the virtual lines Ya-Ya and Yb-Yb are used as the virtual lines in the present invention. In the present embodiment, the virtual line Ya-Ya is the virtual line passing through the folding line 150a for primary tab and the folding line 152a for auxiliary tab. In the present embodiment, the virtual line Yb-Yb is the virtual line passing through the folding line 150b for primary tab and the folding line 152b for auxiliary tab.

The engagement mechanism in the present invention is a portion at least partially stamped off the connection flap. In the present embodiment, a primary tab 138b is defined by a roughly C-letter-shaped breaking line in the connection flap 132. An auxiliary tab 140a is defined by a roughly semicircular breaking line in the connection flap 132. An auxiliary tab 140b is defined by a roughly semicircular breaking line in the connection flap 132.

According to the present embodiment, as in the first embodiment, since the folding line 150a for primary tab and the folding line 152a for auxiliary tab are disposed on the same straight line (virtual line Ya-Ya in FIG. 6) on the connection flap 132, and the folding line 150b for primary tab and the folding line 152b for auxiliary tab are disposed on the same straight line (virtual line Yb-Yb in FIG. 6) on the connection flap 132, the single hanging device 116 can be readily removed or unlikely to come off even in the case where the hanging device 116 is provided at an open end of the tubular structure of the carton.

### <Blank>

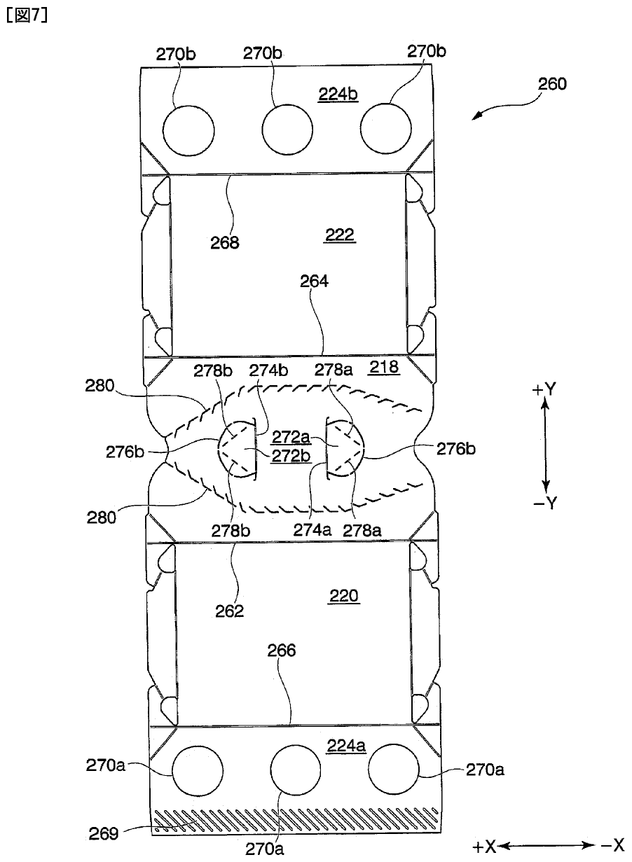

FIG. 7 shows the carton according to the present embodiment in the developed state. Portions corresponding to those in FIG. 1 are labeled with the corresponding reference characters to which 200 is added and will not be described.

A blank 260 shown in FIG. 7 is a paperboard blank for forming a carton that accommodates six beer cans. The blank 260 includes a top wall panel 218, which covers the top surfaces of the beer cans, sidewall panels 220 and 222, which cover the side surfaces of the beer cans, and bottom wall panels 224a and 224b, which cover the bottom surfaces of the beer cans. The top wall panel 218 and the sidewall panel 220 are connected to each other via a folding line 262. The top wall panel 218 and the sidewall panel 222 are connected to each other via a folding line 264. The sidewall panel 220 and the bottom wall panel 224a are connected to each other via a folding line 266. The sidewall panel 222 and the bottom wall panel 224b are connected to each other via a folding line 268.

The bottom wall panel 224a is provided with an overlap width 269, onto which an adhesive is applied. The adhesive applied onto the overlap width 269 fixes the bottom wall panel 224a to the bottom wall panel 224b, achieving a closed tubular structure. A carton having the tubular structure is thus formed. Openings 270a and 270b are formed in the bottom wall panels 224a and 224b, respectively. As a result, when the carton is formed, the user can satisfactorily view the bottom surfaces of the beer cans (in particular, information printed on the bottom surfaces of beer cans), which are packaged objects, via the openings 270a and 270b.

The top wall panel 218 of the blank 260 is provided with finger-hooked tags 272a and 272b for forming finger-hooked openings of the carton. Specifically, the free ends of the finger-hooked tags 272a and 272b of the blank 260 are defined in the top wall panel 218 by roughly C-letter-shaped breaking lines 276a and 276b. The base ends of the finger-hooked tags 272a and 272b are connected to the top wall panel 218 of the blank 260 via folding lines 274a and 274b. Pushing the finger-hooked tags 272a and 272b of the blank 260 inward along the folding lines 274a and 274b allows formation of finger-hooked openings in the top wall panel 218.

In the top wall panel 218, the finger-hooked tags 272a and 272b are each so provided as to be located in the space between the sidewalls of adjacent beer cans. The user can therefore securely catch the inner side of the top wall panel 218 with fingers via the finger-hooked openings formed in the top wall panel 218, whereby the user can securely hold the carton that accommodates the beer cans.

Triangular folding lines 278a and 278b are formed at the finger-hooked tags 272a and 272b. Therefore, when the finger-hooked tags 272a and 272b are folded inward along the triangular folding lines 278a and 278b, and the user lifts the carton with the fingers inserted into the finger-hooked openings, the triangular folding lines 278a and 278b of the finger-hooked tags 272a and 272b extend along the side surfaces of the beer cans, whereby the user more readily carry the carton.

Unsealing perforations 280 are formed in the top wall panel 218. To unseal the carton, lifting the top wall panel 218 upward causes a central portion of the top wall panel 218 to break along the unsealing perforations 280, so that the carton is unsealed. The beer cans accommodated in the carton can thus be taken out all at once.

As described above, the package according to the present embodiment, which includes the hanging device according to the present embodiment, also provides the following advantages: That is, a typical hanging device has a concern of someone's removal of the hanging device from the carton, whereas the hanging device according to the present embodiment makes it difficult to remove the hanging device from the carton once the hanging device is attached to the carton and the auxiliary tabs are folded inward. Further, a typical hanging device makes it difficult in some cases to remove the hanging device from the carton, whereas the hanging device according to the present embodiment allows the user to readily remove the hanging device from the carton by folding the auxiliary tabs outward.

### <Variations>

The present invention is not limited to the embodiments described above, and a variety of variations are conceivable to the extent that the variations fall within the scope of the substance of the present invention.

The tote main body of the hanging device can be one or more elements selected from the group consisting of a supporting back panel to which a hanging device, a product bag, a sales promotion item, a coupon or any other object can be attached, an arbitrarily styled carton or box (basket-shaped carrier, a cup carrier, an end-side carton, a wraparound carton, and a top engagement carrier), but not limited thereto.

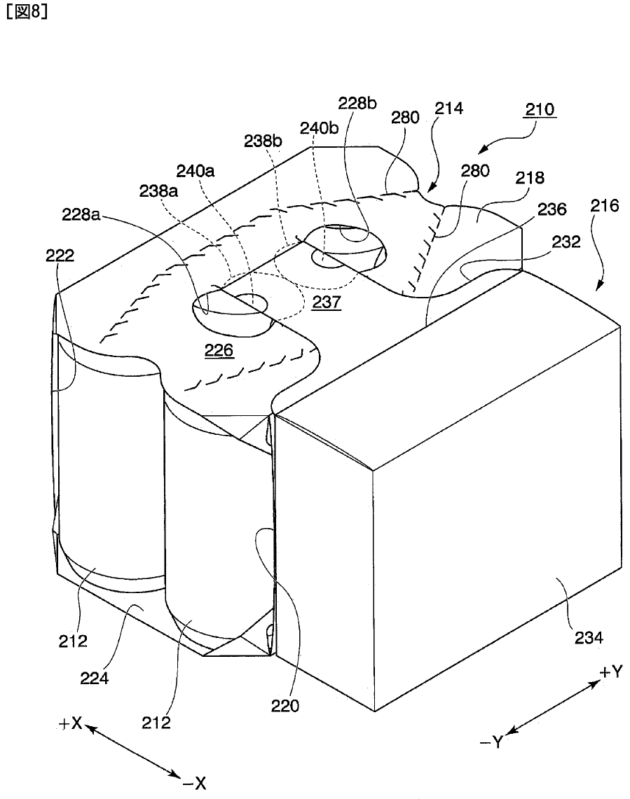

More specifically, the first and second embodiments have been described with reference to the case where a panel is used as the tote main body of the hanging device, and a box-shaped body, such as that shown in FIG. 8, can be preferably used in place of a panel.

FIG. 8 shows a schematic configuration of a package using a hanging device according to a third embodiment of the present invention. Portions corresponding to those in FIG. 1 are labeled with the corresponding reference characters to which 200 is added and will not be described. A hanging device 216 shown in FIG. 8 includes a box-shaped body that accommodates an additional object, such as free gift, as a tote main body 234.

The box-shaped body as the tote main body 234 is connected to a connection flap 232 via a folding line 236 for tote main body. According to the present embodiment, in which the hanging device 216 is provided, auxiliary tabs 240a and 240b allow the single hanging device 216 to be readily removed and unlikely to come off, as in the first and second embodiments.

Further, according to the present embodiment, in which the box-shaped body is provided as the tote main body of the hanging device in place of the advertisement panel described in the first and second embodiments, advertisement information displayed on the box-shaped body can be provided to the user, and an additional object, such as a free gift, accommodated in the box-shaped body can be readily provided.

The above embodiments have been described with reference to the case where beer cans are used as the packaged object, but an aspect of the present invention is not limited thereto, and a packaged object made of another material, such as bottles and PET bottles, can be used.

The above embodiments have been described with reference to the case where cylindrical beer cans are used, but the present invention is not limited thereto, and a packaged object having a shape other than a cylindrical object can be used.

The above embodiments have been described with reference to the case where beer cans filled with beer are used, but an aspect of the present invention is not limited thereto, and a packaged object filled with any other content, such as juice or any other beverage, food, cosmetics, medical supplies, daily commodities, automobile supplies, agricultural supplies, and building supplies.

The above embodiments have been described with reference to the case where the carton accommodates six beer cans, but an aspect of the present invention is not limited thereto, and the carton can accommodate packaged objects the number of which is not six.

The above embodiments have been described with reference to the case where the carton accommodates six beer cans arranged in a 3×2 matrix, but an aspect of the present invention is not limited thereto, and the beer cans may be arranged in a matrix other than a 3×2 matrix.

The above embodiments have been described with reference to the case where a paperboard is used as the packaging material, but an aspect of the present invention is not limited thereto, and a variety of sheets having desired flexibility or rigidity, such as a composite material of paper and resin and a laminate material, can also be used.

### INDUSTRIAL APPLICABILITY

The present invention is applicable to a hanging device and a package including auxiliary tabs that allow a single hanging device to be unlikely to come off or readily removed so that the hanging device is readily handled.

### REFERENCE SIGNS LIST

10, 100, 200 Package
12, 112, 212 Beer cans (packaged object)
14, 114, 214 Carton (package)
16, 116, 216 Hanging device
18, 118, 218 Top wall panel (wall panel)
28a, 28b, 128a, 128b, 228a, 228b Finger-hooked opening
32, 132, 232 Connection flap
34, 134, 234 Tote main body
36, 136, 236 Folding line for tote main body
37, 137, 237 Engagement mechanism
38a, 38b, 138a, 138b, 238a, 238b Primary tab (engagement mechanism)
40a, 40b, 140a, 140b, 240a, 240b Auxiliary tab (engagement mechanism)
50a, 50b, 150a, 150b, 250a, 250b Folding line for primary tab
52a, 52b, 152a, 152b, 252a, 252b Folding line for auxiliary tab

What is claimed is:

1. A hanging device detachably attached to an opening of a package, the hanging device comprising:
a connection flap; and a tote main body connected to the connection flap,
wherein the connection flap has at least one engagement mechanism that detachably engages with the opening of the package,
the at least one engagement mechanism includes a primary tab disposed at the opening of the package and an auxiliary tab connected to the primary tab,
the primary tab is connected to the connection flap in the form of hinge connection along a virtual line, and
when the hanging device is developed, the auxiliary tab extends from the virtual line in a direction opposite a direction in which the primary tab extends.

2. The hanging device according to claim 1,
wherein the primary tab is connected to the connection flap along a folding line for primary tab,
the auxiliary tab is connected to the primary tab along a folding line for auxiliary tab, and
the folding line for primary tab is aligned with the virtual line with which the folding line for auxiliary tab is aligned.

3. The hanging device according to claim 1,
wherein the at least one engagement mechanism includes a pair of engagement mechanisms so disposed as to face each other, and
when the hanging device is developed, the auxiliary tabs of the engagement mechanisms extend from the corresponding primary tabs in opposite directions.

4. The hanging device according to claim 2,
wherein the tote main body is connected to the connection flap along a folding line for tote main body, and
the folding line for auxiliary tab is so disposed as to be perpendicular to the folding line for tote main body.

5. The hanging device according to claim 1,
wherein the tote main body is connected to the connection flap along a folding line for tote main body, and
the virtual line is so disposed as to be parallel to the folding line for tote main body.

6. The hanging device according to claim 1, wherein the at least one engagement mechanism is a portion at least partially stamped off the connection flap.

7. A package comprising: at least one packaged object; a carton that is a package at least partially disposed around the at least one packaged object; and a hanging device detachably attached to the carton,
wherein the carton includes a plurality of wall panels connected in the form of hinge connection to each other,
the plurality of wall panels include a top wall panel having a carrying handle, and the carrying handle has at least one finger-hooked opening,
the hanging device includes a tote main body disposed along at least part of an exterior of the carton and a connection flap having at least one engagement mechanism that engages with the at least one finger-hooked opening of the carton,
the at least one engagement mechanism includes a primary tab disposed at the at least one finger-hooked opening and an auxiliary tab connected to the primary tab,
the primary tab is connected to the connection flap in the form of hinge connection along a virtual line, and
when the hanging device is developed, the auxiliary tab extends from the virtual line in a direction opposite a direction in which the primary tab extends.

8. The package according to claim 7,
wherein the plurality of wall panels define a tubular structure having at least one open end, and
the tote main body is provided in a position where the tote main body at least partially closes the at least one open end of the tubular structure.
